(19) United States
(12) Patent Application Publication
(10) Pub. No.: US 2025/0356566 A1
(43) Pub. Date: Nov. 20, 2025

(54) GENERATING IMAGES USING A MACHINE LEARNING MODEL

(71) Applicant: Lemon Inc., Grand Cayman (KY)

(72) Inventors: You Xie, Los Angeles, CA (US); Hongyi Xu, Los Angeles, CA (US); Guoxian Song, Los Angeles, CA (US); Chao Wang, Los Angeles, CA (US); Yichun Shi, Los Angeles, CA (US); Linjie Luo, Los Angeles, CA (US)

(21) Appl. No.: 19/193,811

(22) Filed: Apr. 29, 2025

Related U.S. Application Data
(60) Provisional application No. 63/649,734, filed on May 20, 2024.

(51) Int. Cl. G06T 13/40; G06T 7/215; G06T 7/246; G06T 7/73; G06T 13/80

(52) U.S. Cl. CPC G06T 13/40; G06T 7/215; G06T 7/248; G06T 7/251; G06T 7/74; G06T 13/80; G06T 2207/10016; G06T 2207/20081; G06T 2207/30201

(57) ABSTRACT

The present disclosure describes techniques for generating images using a machine learning model. A source image and a driving image are received. The source image comprises a portrait of a first subject. The driving image comprises a second subject and depicts a pose or a visage. Appearance features of the first subject are extracted from the source image by a first sub-model of the machine learning model. A masked image is generated based on the driving image. The masked image comprises a mouth region and/or eye regions in the driving image. The pose or the visage is derived based on the driving image and the masked images by a second sub-model of the machine learning model. An image is generated by the machine learning model. The image preserves the appearance features of the first subject and follows the pose or the visage depicted in the driving image.

### CROSS-REFERENCE TO RELATED APPLICATION

The present application claims priority to U.S. Provisional Application No. 63/649,734, filed on May 20, 2024, which is incorporated herein by reference in its entirety.

### BACKGROUND

Machine learning models are increasingly being used across a variety of industries to perform a variety of different tasks. Such tasks can include content generation. Improved techniques for utilizing machine learning models for content generation are desirable.

### BRIEF DESCRIPTION OF THE DRAWINGS

The following detailed description can be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating images and/or videos using a machine learning model in accordance with the present disclosure.

FIG. 2 shows an example system for generating images and/or videos using a machine learning model in accordance with the present disclosure.

FIG. 3 shows an example system for generating videos using a machine learning model in accordance with the present disclosure.

FIG. 4 shows an example system for training a machine learning model in accordance with the present disclosure.

FIG. 5 shows an example process for generating images using a machine learning model in accordance with the present disclosure.

FIG. 6 shows an example process for training a second sub-model of a machine learning model in accordance with the present disclosure.

FIG. 7 shows an example process for generating a control image in accordance with the present disclosure.

FIG. 8 shows an example process for training a second sub-model of a machine learning model in accordance with the present disclosure.

FIG. 9 shows an example process for training a machine learning model in accordance with the present disclosure.

FIG. 10 shows an example process for generating videos using a machine learning model in accordance with the present disclosure.

FIG. 11 shows example evaluation results in accordance with the present disclosure.

FIG. 12 shows example evaluation results in accordance with the present disclosure.

FIG. 13 shows an example computing device which can be used to perform any of the techniques disclosed herein.

### DETAILED DESCRIPTION OF ILLUSTRATIVE EMBODIMENTS

Machine learning models can be used for generating portrait animations. In particular, machine learning models can be used to animate a static portrait image using motion information, such as head poses, and/or facial aspects/visages, derived from a driving image or video, with the driving image of video often featuring a different subject than the static portrait image. Portrait animation has gained significance in a variety of different downstream applications, such as video conferencing, visual effects, and digital agents.

Described herein are improved techniques for generating portrait animations. The improved techniques described herein can be used to generate high-fidelity videos of in-the-wild portraits in diverse styles, exhibiting highly dynamic head poses and expressive facial visages. A machine learning model can leverage image diffusion priors for expressive portrait animation and a pose control scheme to mitigate expressiveness loss and appearance leakage. To fully retain the driving head poses and facial visages, motion is interpreted directly from the original driving images, without resorting to any intermediate motion representation. A motion transfer network is employed to generate cross-identity training image pairs for training the machine learning model. The cross-identity driven training scheme simultaneously mitigates appearance leakage, enabling direct portrait animation during inference without any pre-processing. To further enhance the derivation of subtle facial visages at nuanced scales, an auxiliary ControlNet is employed to guide the conditional motion attention to local facial movements.

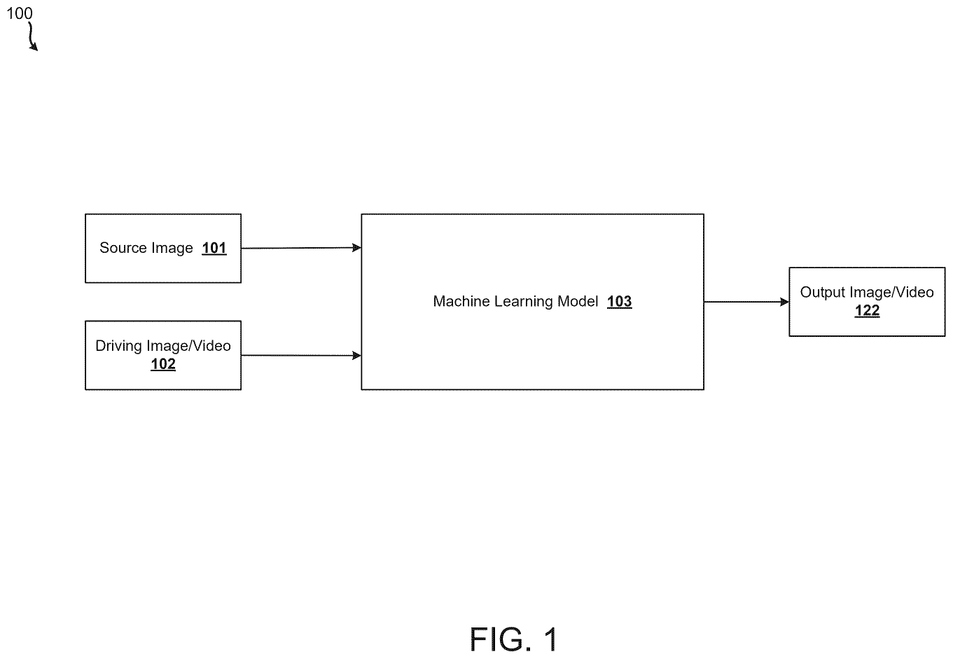

FIG. 1 illustrates an example system 100 in accordance with the present disclosure. The system 100 can be used for image or video generation using a machine learning model 103. For example, the system 100 can generate an output image or video using a single portrait image and driving frame(s) from a driving video.

A source image 101 and a driving image/video 102 can be input into the machine learning model 103. The source image 101 can include a portrait of a subject (e.g., user, individual, person). The source image 101 can include an image of a face of the subject. The driving image/video 102 can depict a pose (e.g., a head pose) or a visage (e.g., facial aspect). In embodiments, the driving image/video 102 can depict the same subject in a certain pose or having a certain visage. For example, the driving image/video 102 and the source image 101 can be extracted from the same video (e.g., the driving image/video 102 and the source image 101 can be different frames of the same video). In other embodiments, the driving image/video 102 can depict a different subject in a certain pose or having a certain visage.

The machine learning model 103 can be trained to generate an output image/video 122 based on transferring the head pose and/or facial aspect associated with the driving image/video 102 to the subject depicted in the source image 101. For example, if the subject depicted in the source image 101 having a first visage or pose (e.g., smiling), and the driving image/video 102 depicts a subject (e.g., different subject) that has a different visage or pose (e.g., not smiling), the machine learning model 103 can generate an output image/video 122 that depicts the subject of the source image having the different visage or pose (e.g., not smiling).

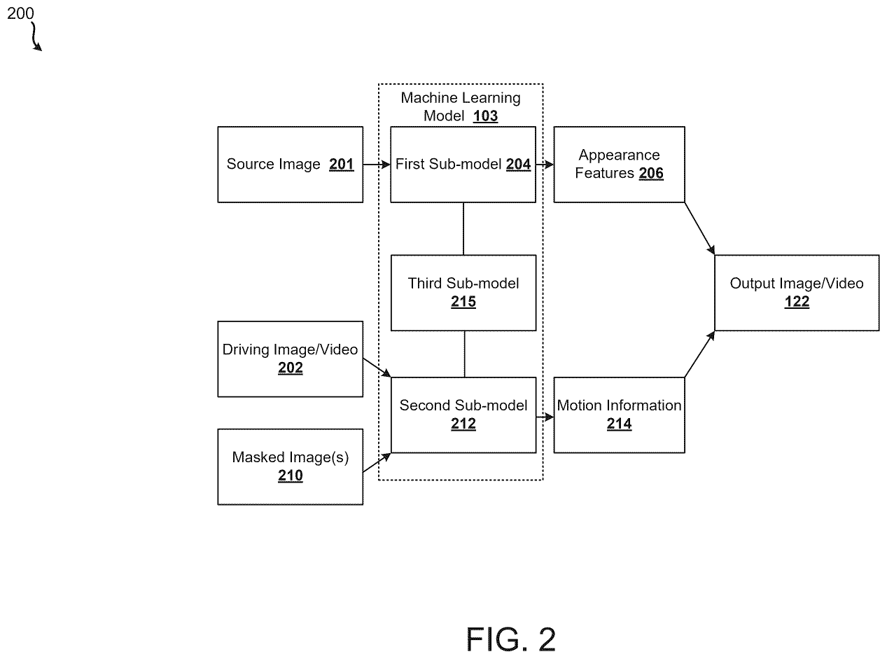

FIG. 2 illustrates an example system 200 in accordance with the present disclosure. The system 200 can be used for image or video generation using the machine learning model 103. The machine learning model 103 can include a first sub-model 204, a second sub-model 212, and a third sub-model 215.

The machine learning model 103 can receive a source image 201 and a driving image/video 202. The source image 201 can include a portrait of a first subject (e.g., human), while the driving image/video 202 can include at least one portrait of a second subject that is different from the first subject. The driving image/video 202 can depict a pose (e.g., a head pose) or a visage (e.g., facial aspect). The source image 201 can be input into the first sub-model 204. The first sub-model 204 can extract identity features 206 (appearance features, such as facial features) of the first subject from the source image 201. At least one masked image 210 can be generated based on the driving image/video 202. The masked image(s) 210 can include at least one of a mouth region or eye regions in the driving image/video 202. The driving image/video 202 and the masked image(s) 210 can be input into the second sub-model 212. The second sub-model 212 can derive motion information 214, such as information indicating the pose or the visage, based on the driving image/video 202 and the masked image(s) 210. The third sub-model 215 can be trained to implement temporal smoothness. The machine learning model 103 can generate the output image/video 122 with temporal smoothness based on the identity features 206 and the motion information 214. The output image/video 122 can preserve the identity features of the first subject and can follows the pose or the visage depicted in the driving image/video 202. In some embodiments, the machine learning model 103 can leverage a frozen pre-trained latent diffusion model as a rendering backbone and incorporate the three sub-models 204, 212 and 215 for disentangled control of appearance, motion and temporal smoothness.

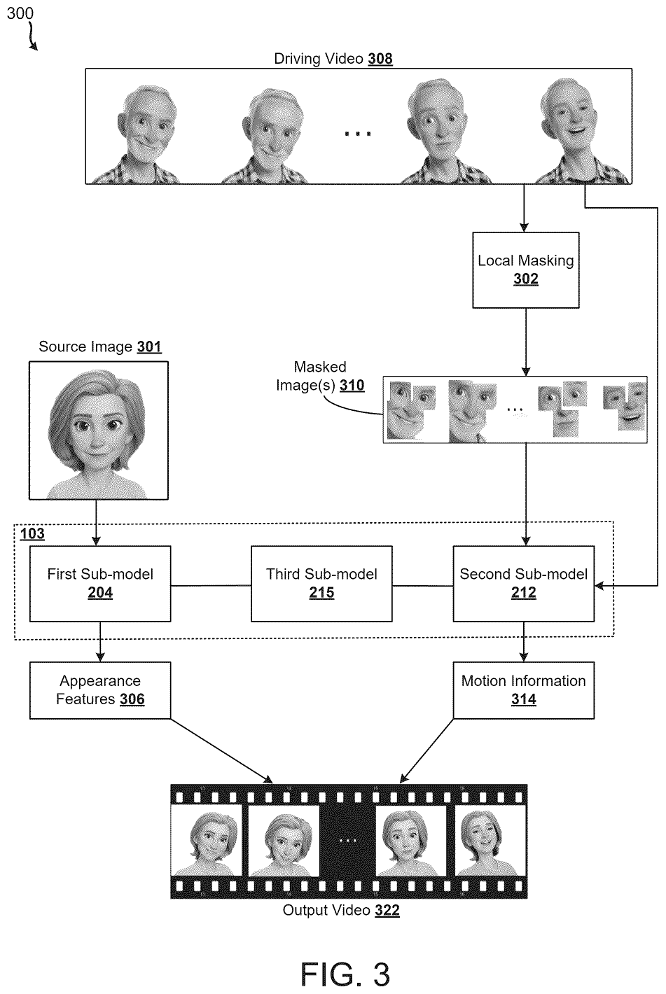

FIG. 3 illustrates an example system 300 in accordance with the present disclosure. The system 300 can be used for video generation using the machine learning model 103. The machine learning model 103 can include the first sub-model 204, the second sub-model 212, and the third sub-model 215. Given one or more static portraits I_{S}, such as the source image 301, the system 300 can generate a head animation sequence {I_{S}−Dᵢ}, such as the head animation sequence depicted in output video 322, with a length of q, conditioned on a driving video I_{D}_{ᵢ}, such as the driving video 308, where i=0, . . . , q denotes the frame index.

The machine learning model 103 can receive a source image 301 and a driving video 308. The source image 301 can include a portrait of a first subject (e.g., identity including appearance features, such as facial features, of the first subject), while the driving video 308 can include at least one portrait of a second subject that is different from the first subject. The driving video 308 can depict a pose (e.g., a head pose) or a visage (e.g., facial aspect). The source image 301 can be input into the first sub-model 204. The first sub-model 204 can extract identity features 306 of the first subject from the source image 301. At least one masked image 310 can be generated based on the driving video 308. For example, at least one masked image 310 can be generated for each frame of the driving video 308.

The masked image(s) 310 can include at least one of a mouth region or eye regions of the second subject in the driving video 308. The driving video 308 and the masked image(s) 310 can be input into the second sub-model 212. The second sub-model 212 can derive motion information 314, such as information indicating the pose or the visage, based on the driving video 308 and the masked image(s) 310. The machine learning model 103 can generate the output video 322 based on the identity features 306 and the motion information 314. The output video 322 can preserve the identity features of the first subject and background content depicted in the source image 301 and can follow the pose or the visage depicted in the driving video 308. To generate the output video 322, the machine learning model 103 can leverage one or more latent diffusion models, with disentangled control of appearance, motion and temporal smoothness. The latent diffusion model(s) can include generative models designed to synthesize desired data samples from Gaussian noise z_{T}˜N (0, 1) through T denoising steps. The latent diffusion models can operate in the latent space facilitated by a pretrained auto-encoder.

To achieve control of facial visages and head poses with image diffusion models, existing techniques typically employ a ControlNet trained to condition image generation on facial landmarks. A control module can be trained to reconstruct ID conditioned on the landmarks input extracted from the target I_{D}, with I_{S} as the input to an appearance reference module R. I_{S} and I_{D} can be two random video frames during training, featuring the same subject. While effective at a coarse scale, such a control scheme induces several problems, particularly when zoomed in on faces. First, the accuracy of the driving signals is heavily dependent on the precision of third-party detectors. This dependence introduces jittered controls, motion ambiguity, and can result in corrupted animation when the detection fails, for example, due to face occlusion. Second, the conveyance of strong emotions or subtle expressions often involves detailed facial movements, such as those in the teeth, eyeballs, eyebrows, and ajna. The animation expressiveness can be significantly hindered by the coarse landmark representation, which cannot capture the nuances demanded for accurate facial animation. Lastly, the driving landmarks are aligned with the face structure of targeted image I_{D}, featuring the same subject as in I_{S}. Thus, under the self-driven training scheme, the existing techniques, as a short-cut, tend to copy the driving structure entangled with identity features such as facial shapes and ratios. As a result, undesirable identity drift to the driving subject occurs during cross-identity animation in inference.

To address the aforementioned issues, the machine learning model 103 includes the second sub-model 212 (e.g., control sub-model C). The second sub-model 212 can include a novel conditional motion control that is entirely disentangled from the source identity features, while minimizing the loss of motion information at all scales, such as facial expressions and head poses. The original driving RGB image I_{D}, featuring a different subject than I_{S}, can be used as conditional input to the second sub-model 212. This can enable the direct reenactment of the source image onto the driving video of a different identity (a different subject, e.g., a different person). However, such image pairs with distinct identities but with aligned motions are not readily accessible for training.

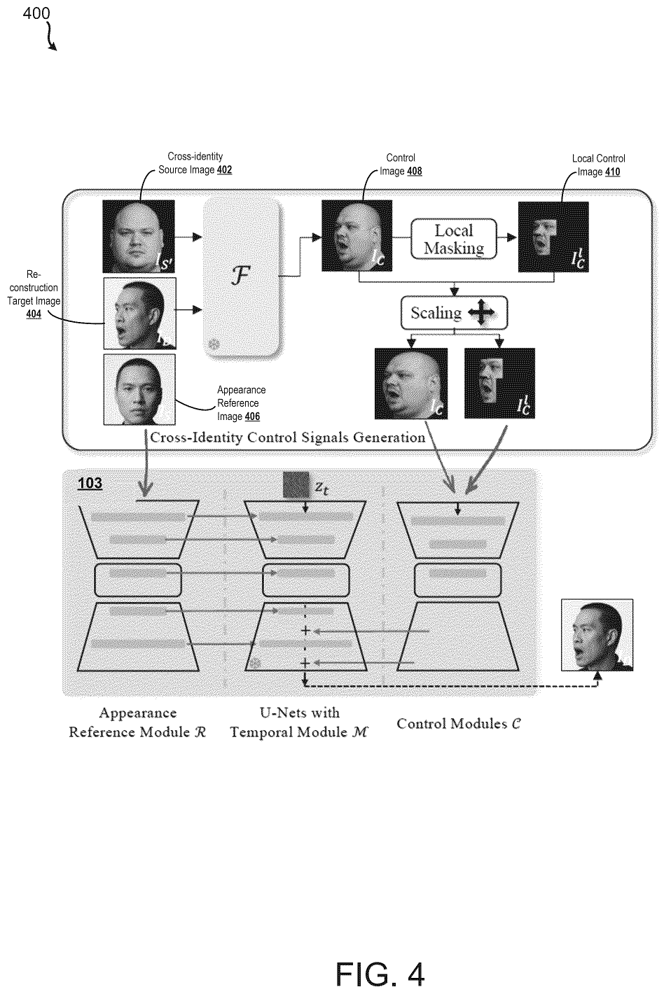

FIG. 4 illustrates an example system 400 in accordance with the present disclosure. The system 400 can be used for training of the machine learning model 103, including the second sub-model 212. The second sub-model 212 can be trained by applying a cross-identity training scheme. The cross-identity training scheme can be configured to instruct the second sub-model 212 to derive identity-disentangled poses or visages.

Applying the cross-identity training scheme can include generating cross-identity image pairs. Each cross-identity image pair can include images of different subjects. The generation of the cross-identity image pairs can be facilitated by a pre-trained portrait reenactment network F. Two randomly selected video frames featuring the same subject (e.g., an appearance reference image 406 and a reconstruction target image 404) can be selected. Instead of relying on facial landmarks from the reconstruction target image 404, the pre-trained portrait reenactment network F can generate an RGB control image 408 as the conditional input to the second sub-model 212. The control image 408 is generated based on a cross-identity source image 402 and the reconstruction target image 404, where the cross-identity source image 402 is a frame randomly selected from a video with a distinct identity. The cross-identity source image 402 can depict a subject that is different from the subject in the appearance reference image 406 and the reconstruction target image 404. The control image 408 can depict the same subject as the cross-identity source image 402. The control image 408 can share motion information with the reconstruction target image 404. The second sub-model 212 can be trained on the cross-identity image pairs to mitigate appearance leakage from driving signals. In examples, each cross-identity image pair can comprise the appearance reference image 406, the reconstruction target image 404, and the control image 408.

This cross-identity training scheme effectively instructs the second sub-model 212 to implicitly derive the identity-disentangled motion from the control image 408. This can mitigate appearance leakage from the driving signal, allowing direct application of the driving video for inference without third-party dependency. The pre-trained portrait reenactment network F offers reenacted control image 408 of reasonable quality and motion accuracy for widely distributed conversational scenarios. Even with limited perceptual quality, the control image 408 contains richer motion information than landmarks, which is sufficient for the second sub-model 212 to decipher the embedded motion structure effectively, enabling it to adapt and correlate to finer expressions and poses when provided with ground-truth motions for supervision. As such, the second sub-model 212 is able to establish implicit structural mapping between the control image 408 and the reconstruction target image 404, generalizing well to unseen expressions and head motions.

The trained second sub-model 212 offers a significant improvement over coarse landmarks in capturing head transformations and low frequency facial expressions. The trained second sub-model 212 can extract structural features from the control image 408 and can integrate into the UNets via skip connections during the denoising process. However, such additive conditional attention operates in the global image space, treating motion in every pixel with equal weight.

To guide the second sub-model 212 to enhance localized attention specifically to critical facial regions, aimed at better animation realism and finer control granularity, an auxiliary ControlNet is introduced. Motion control at nuanced scales can be achieved using the auxiliary ControlNet that conditions on a local control image 410, revealing only patches around the eyes and mouth from the control image 408. Specifically, landmarks of the control image 408 can be detected for the eyes and mouth, and the centers of the landmarks can be used to crop patches of 128×128 as local control images 410. This control branch effectively provides enhanced guidance to the UNet denoising, focusing solely on the local structure extracted from those cropped facial regions. The enhanced generator helps in capturing the subtle motions in the hierarchical conditional inputs (control image 408 and local control image 410), benefiting the subsequent training of both control modules.

The first sub-model 204 (e.g., appearance reference module R) can ensure the preservation of source identity characteristics. The first sub-model 204 can derive appearance features from the appearance reference image 406, which can then be concatenated into the UNet transformer blocks. Simultaneously, the cross-identity training scheme with reenacted control image 408 substantially mitigates the appearance leakage from the driving signals. However, inherited from its self-supervised training, the pre-trained image reenactment generator F is not entirely free from appearance entanglement. Consequently, the facial attributes of the control image 408, especially in terms of face shape and the sizes of the eyes/mouth, can be compromised by the reconstruction target image 404, resulting in slight identity drifts, especially when there are substantial differences in facial appearance between the source and driving.

To alleviate these slight identity drifts, the control image 408 and local control image 410 can be adjusted (e.g., scaled) with random heterogeneous scaling during training. This can induce slight face distortions and structure misalignments between the control image 408/local control image 410 and the reconstruction target image 404, forcing the network to rely on the appearance reference image 406 for identity features. The scaling operations can only impact head shapes and cannot modify the driving facial expressions and head poses. While excessive induced misalignment can hinder the learning of the control modules, a random scaling factor within the range [0.9, 1.1] strikes a balance between identity preservation and motion expressiveness. Additionally, during cross-identity driven inference, the facial shape differences can be minimized by applying an affine transformation (translation and scaling) over the entire driving sequence to align the head bounding box of the source and a selected driving frame.

With a single appearance reference image 406, only partial facial appearance is visible, and the network has to rely on the universal generative prior of LDM for inpainting unobserved facial regions when altering head poses or camera views. However, when more reference images are accessible, such as in a video, a more comprehensive appearance context can be incorporated without any network modification. Owing to the disentangled controls described herein, by simply concatenating the multiple extracted appearance features into the UNets with the first sub-model 204 (e.g., appearance reference module R), the framework described herein can seamlessly fuse them and generate animations with better-retained identity attributes.

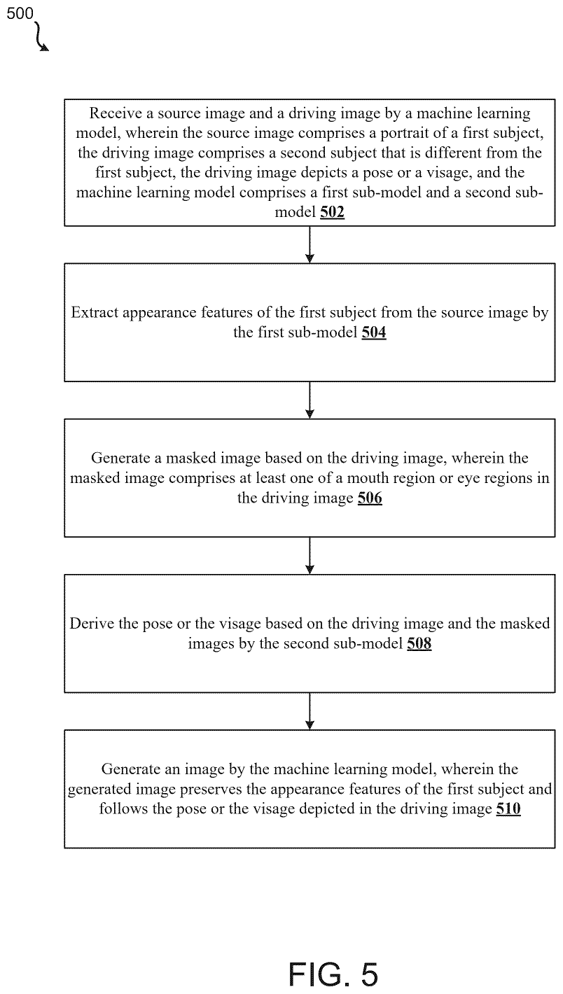

FIG. 5 illustrates an example process 500 for generating images using a machine learning model. Although depicted as a sequence of operations in FIG. 5, those of ordinary skill in the art will appreciate that various embodiments can add, remove, reorder, or modify the depicted operations.

At 502, a source image (e.g., source image 201) and a driving image (e.g., driving image/video 202) can be received. The source image and the driving image can be received by a machine learning model (e.g., machine learning model 103). The machine learning model can include a first sub-model (e.g., first sub-model 204) and a second sub-model (e.g., second sub-model 212). The source image can comprise a portrait of a first subject. The driving image can comprise a second subject that is different from the first subject. The driving image can depict a pose or a visage.

The source image can be input into the first sub-model. At 504, identity features (appearance features, such as facial features) of the first subject can be extracted from the source image by the first sub-model. At 506, at least one masked image (e.g., masked image 210) can be generated based on the driving image. The masked image(s) can include at least one of a mouth region or eye regions in the driving image. The driving image and the masked image(s) can be input into the second sub-model. At 508, motion information, such as information indicating the pose or the visage, can be derived based on the driving image and the masked image(s) by the second sub-model. At 510, an image (e.g., output image/video 122) can be generated by the machine learning model. The generated image can preserve the identity features of the first subject and follow the pose or the visage depicted in the driving image.

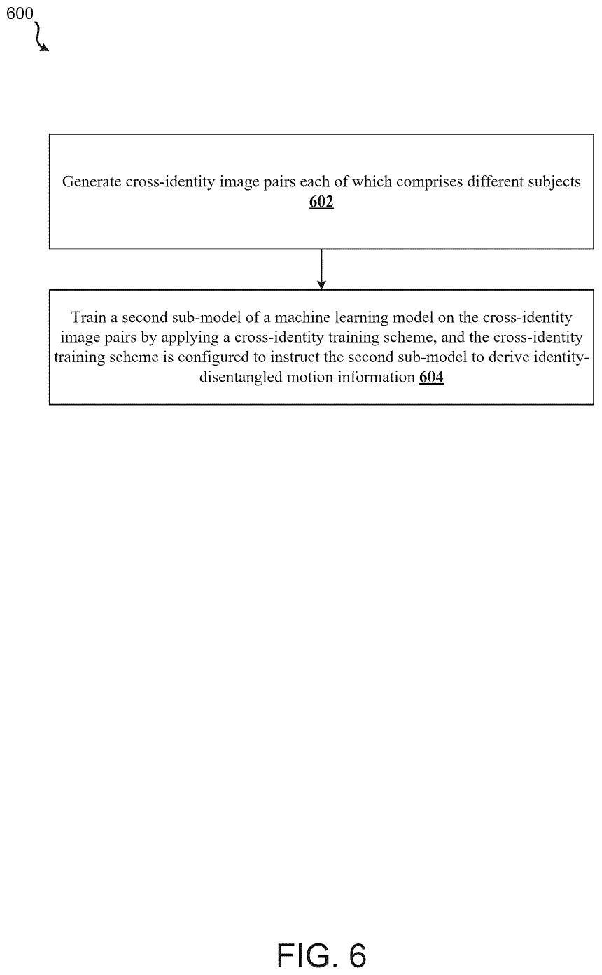

FIG. 6 shows an example process 600 for training a second sub-model model (e.g., second sub-model 212) of a machine learning model (e.g., machine learning model 103) in accordance with the present disclosure. Although depicted as a sequence of operations in FIG. 6, those of ordinary skill in the art will appreciate that various embodiments can add, remove, reorder, or modify the depicted operations.

At 602, cross-identity image pairs can be generated. Each cross-identity image pair can include images of different subjects. The generation of the cross-identity image pairs can be facilitated by a pre-trained portrait reenactment network F. At 604, the second sub-model of the machine learning model can be trained on the cross-identity image pairs by applying a cross-identity training scheme. The cross-identity training scheme can be configured to instruct the second sub-model to derive identity-disentangled motion information. The second sub-model can be trained on the cross-identity image pairs to mitigate appearance leakage from driving signals.

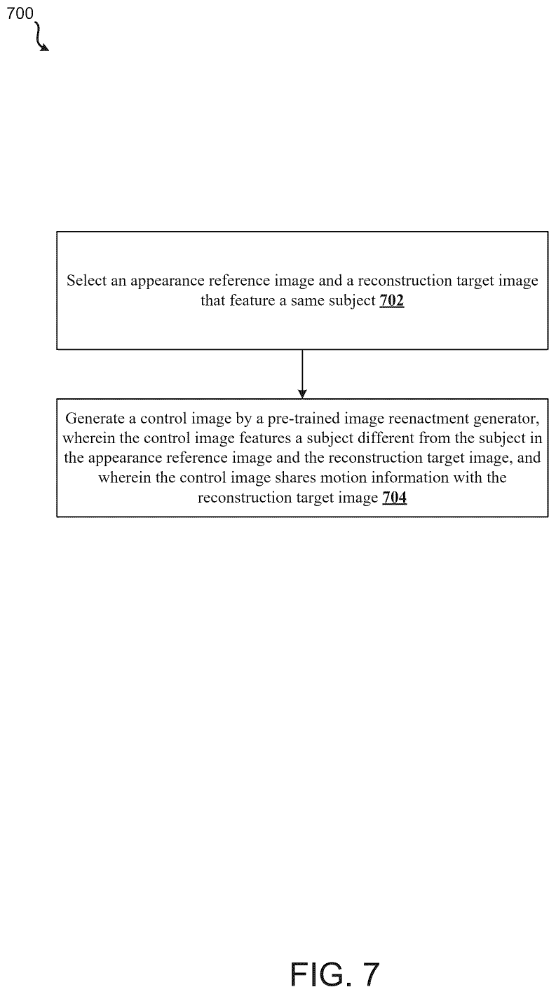

FIG. 7 shows an example process 700 for generating a control image in accordance with the present disclosure. Although depicted as a sequence of operations in FIG. 7, those of ordinary skill in the art will appreciate that various embodiments can add, remove, reorder, or modify the depicted operations.

Cross-identity image pairs can be generated. Each cross-identity image pair can include images of different subjects. The generation of the cross-identity image pairs can be facilitated by a pre-trained portrait reenactment network F. At 702, two video frames featuring the same subject (e.g., an appearance reference image 406 and a reconstruction target image 404) can be selected. At 704, an RGB control image (e.g., control image 408) can be generated by the pre-trained portrait reenactment network. The control image can be generated based on a cross-identity source image (e.g., cross-identity source image 402) and the reconstruction target image. The control image can feature a subject different from the subject in the appearance reference image and the reconstruction target image. The control image can share motion information with the reconstruction target image

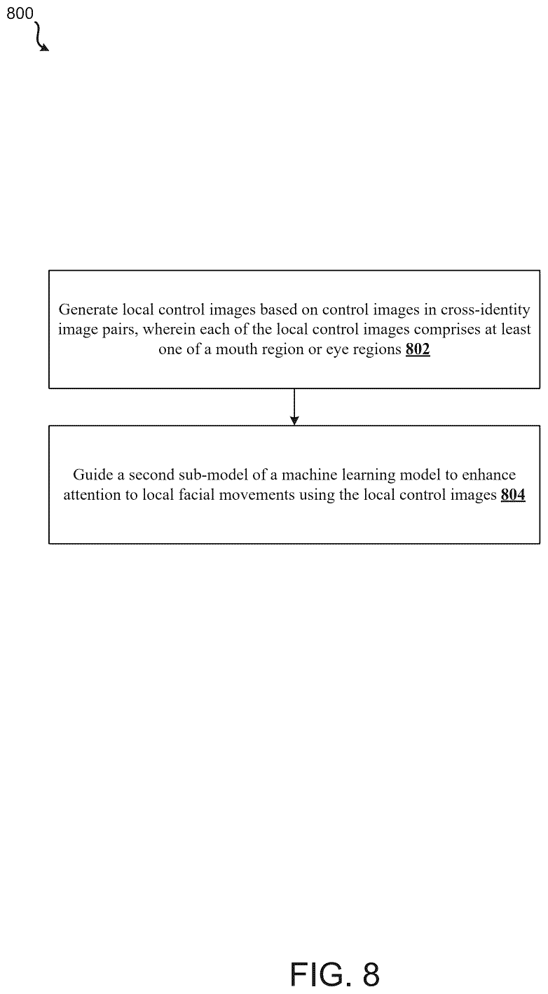

FIG. 8 shows an example process 800 for training a second sub-model (e.g., second sub-model 212) of a machine learning model (e.g., machine learning model 103) in accordance with the present disclosure. Although depicted as a sequence of operations in FIG. 8, those of ordinary skill in the art will appreciate that various embodiments can add, remove, reorder, or modify the depicted operations.

Cross-identity image pairs can be generated. Each cross-identity image pair can include images of different subjects. The generation of the cross-identity image pairs can be facilitated by a pre-trained portrait reenactment network F. An RGB control image (e.g., control image 408) can be generated by the pre-trained portrait reenactment network. At 802, local control images can be generated. The local control images can be generated based on control images in the cross-identity image pairs. Each of the local control images can comprise at least one of a mouth region or eye region(s). A second sub-model (e.g., second sub-model 212) of a machine learning model (e.g., machine learning model 103) can be trained on the cross-identity image pairs by applying a cross-identity training scheme. At 804, the second sub-model of the machine learning model can be guided to enhance attention to local facial movements using the local control images. For example, the second sub-model can be instructed to derive identity-disentangled motion information. The second sub-model can be trained on the cross-identity image pairs to mitigate appearance leakage from driving signals.

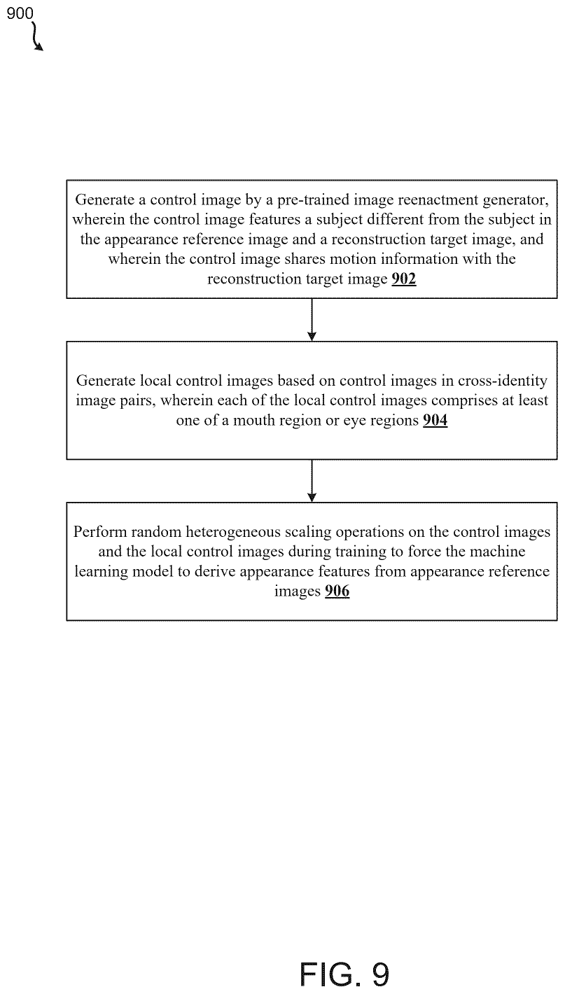

FIG. 9 shows an example process 900 for training a machine learning model (e.g., machine learning model 103) in accordance with the present disclosure. Although depicted as a sequence of operations in FIG. 9, those of ordinary skill in the art will appreciate that various embodiments can add, remove, reorder, or modify the depicted operations.

Two video frames featuring the same subject (e.g., an appearance reference image 406 and a reconstruction target image 404) can be selected. At 902, an RGB control image (e.g., control image 408) can be generated by the pre-trained portrait reenactment network. The control image can be generated based on a cross-identity source image (e.g., cross-identity source image 402) and the reconstruction target image. The control image can feature a subject different from the subject in the appearance reference image and the reconstruction target image. The control image can share motion information with the reconstruction target image.

At 904, local control images can be generated. The local control images can be generated based on control images in the cross-identity image pairs. Each of the local control images can comprise at least one of a mouth region or eye region(s). At 906, random heterogeneous scaling operations can be performed on the control images and the local control images. The random heterogeneous scaling operations can be performed on the control images and the local control images during training to force the machine learning model to derive identity features from appearance reference images. In embodiments, a random scaling factor of the random heterogeneous scaling operations can be greater than or equal to 0.9 and less than or equal to 1.1.

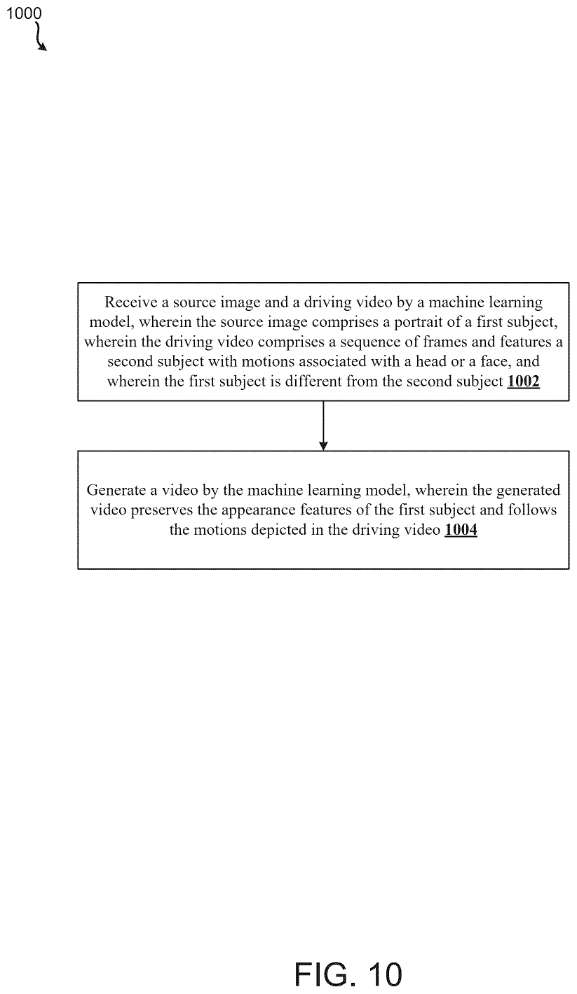

FIG. 10 shows an example process 1000 for generating videos using a machine learning model (e.g., machine learning model 103) in accordance with the present disclosure. Although depicted as a sequence of operations in FIG. 10, those of ordinary skill in the art will appreciate that various embodiments can add, remove, reorder, or modify the depicted operations.

At 1002, a source image (e.g., source image 201) and a driving video (e.g., driving video 202) can be received. The source image and the driving video can be received by a machine learning model (e.g., machine learning model 103). The source image can comprise a portrait of a first subject. The driving video can comprise a second subject that is different from the first subject. The driving video can comprise a sequence of frames. The driving video can feature a second subject with motions associated with a head or a face. The first subject is different from the second subject. At 1004, a video (e.g., output video 122) can be generated by the machine learning model. The generated video can preserve the identity features of the first subject and can follow the motions depicted in the driving video.

Experiments were conducted to evaluate the performance of the machine learning model 103. The machine learning model 103 was trained using a dataset including monocular camera recordings of 42 expressions and 20-min talks from 550 subjects in both indoor and outdoor scenes. All the data were processed with a cropped resolution of 512×512. Sequences of low quality were filtered out with. All videos featured real subjects showcasing a diverse range of expressions and speeches in various scenes. For evaluation, 100 portraits were collected, the portraits depicting various realistic or artistic depictions (2D/3D cartoon, anime, cyberpunk, oil painting, statue, wood, etc.), facial appearances (joker, elf, human-like robot, etc.), apparels (glasses, hat, robe, headphones etc.), and body poses (front and side). The training was conducted in stages, where we sequentially plug in and train the first sub-model 204, the second sub-model 212, and the third sub-model 215. An AdamW optimizer was utilized with a learning rate of 10-5 to train all modules. Each module underwent training with 30K steps with 16 video frames in each step.

During inference, a prompt traveling strategy was leveraged to enhance temporal smoothness. With a frozen SD UNet, the machine learning model 103 demonstrated inherent compatibility with the latent consistency model. This compatibility facilitates the efficient generation of a 24-frame animation within 30 seconds (10 steps) when executed on an A10 GPU. Notably, instead of denoising from random Gaussian noise, the forward diffusion process was applied on the source image into an initialized noise. Such generated noise adds a subtle level of structural guidance at the early denoising step, yielding improved consistency with reduced popping artifacts. The pre-trained portrait reenactment network F was not utilized during inference.

The machine learning model 103 empowers the creation of captivating and highly expressive animations, demonstrating a diverse range of head motions (with rotations over 150 degrees) and facial expressions (frowning, crossed eyes, pouting, etc.) across both realistic, human-like, and style portraits. The machine learning model 103 employs a reference module to effectively cross-query source appearance features, thereby establishing localized spatial correspondences between the input and output. Once trained, the machine learning model 103 is able to generalize to out-of-domain appearances through its learned latent space, as exemplified by stylized portraits. Simultaneously, high identity resemblance to the given source image is maintained throughout the generated video. The machine learning model 103 was compared with prior portrait animation works including state-of-the-art GAN based methods and recent diffusion-based approaches. For fair comparisons, all of the baselines were fine-tuned over the same dataset. We assess their performances over both self and cross reenactments. All numbers are computed at the resolution of 256×256 due to the limited resolution for most of the previous works.

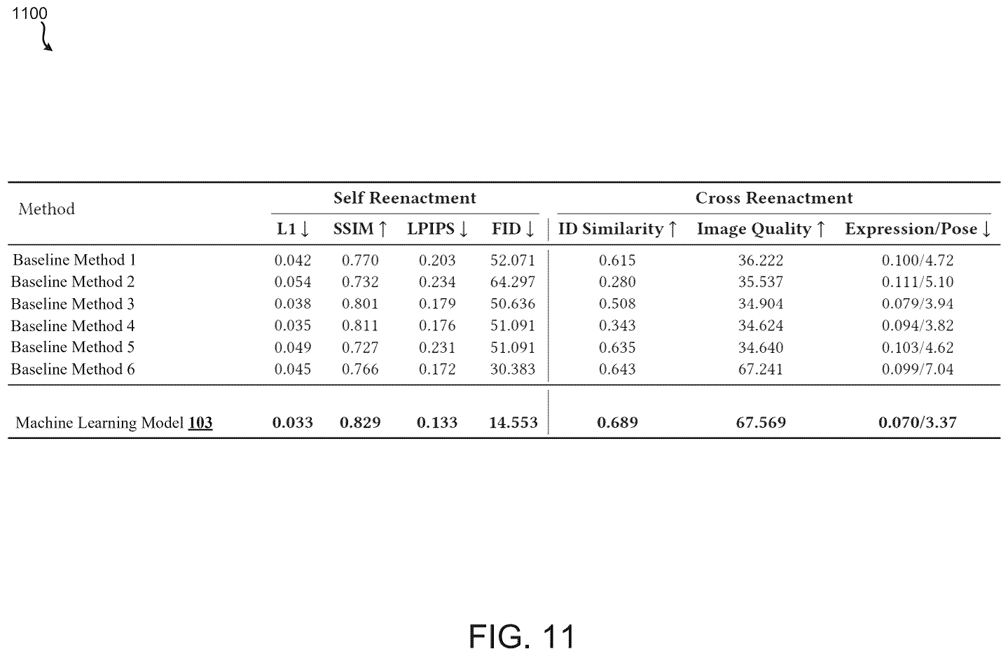

For each test video, the first frame was used as the reference image and the entire sequence was generated where the subsequent frames serve as both driving image and the ground truth target. As shown in the numerical comparisons depicted in the table 1100 of FIG. 11, the machine learning model 103 consistently demonstrates superior image quality and motion accuracy over all the baselines. Given the absence of image ground truth, three metrics were employed to evaluate identity similarity, image quality, and expression and head pose accuracy, respectively. A pre-trained network was employed for image quality assessment. As reported in the table 1100 of FIG. 11, the machine learning model 103 consistently outperforms all competitors by a good margin. Notably, by leveraging the SD prior, the machine learning model 103 surpasses the other methods by a substantial margin in image quality.

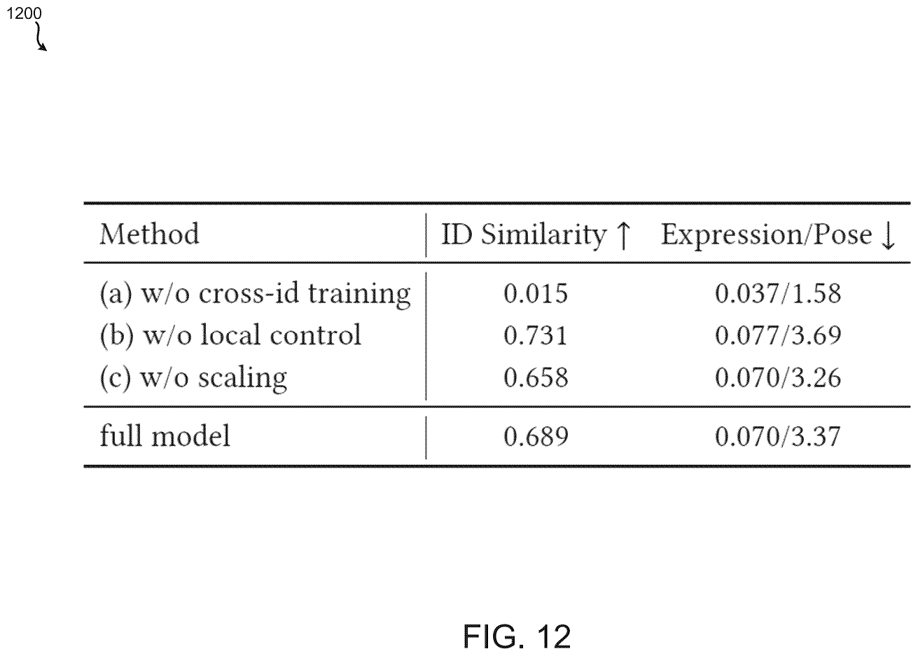

The efficacy of individual components of the machine learning model 103 was ablated by removing them from the full training pipeline, evaluated on cross reenactment synthesis. The machine learning model 103 was trained naively with the driving frame as both the target and motion condition (self-driven training, even with our scaling strategy). In this scenario, the network tends to treat it as an image reconstruction task and merely copies both the identity and motion from the driving frames. Therefore, as shown in the quantitative evaluation depicted in row (a) of the table 1200 of FIG. 12, while the expression accuracy is on par with our full pipeline, there is a significant decrease in identity resemblance. Excluding the local control module results in the absence of expression details, such as the asymmetric frowning, aligning with the observation of decreased expression accuracy (row (b) of table 1200). Furthermore, the source identity features are better maintained with our scaling augmented training strategy without which noticeable identity drift to the driving occurs, as evidenced in row (c) of the table 1200.

In conclusion, the machine learning model 103 ensures meticulous transfer of driving facial expressions and head poses. The machine learning model 103 excels with the incorporation of cross-identity driving inputs in training, facilitating a balanced achievement of motion expressiveness, identity preservation, and animation robustness. The local control module accentuates the attention to detailed facial expressions that are subtle to capture but critical to emotion conveyance. The showcased impressive performance of the machine learning model 103 on generalized source portraits and driving motions validates its effectiveness

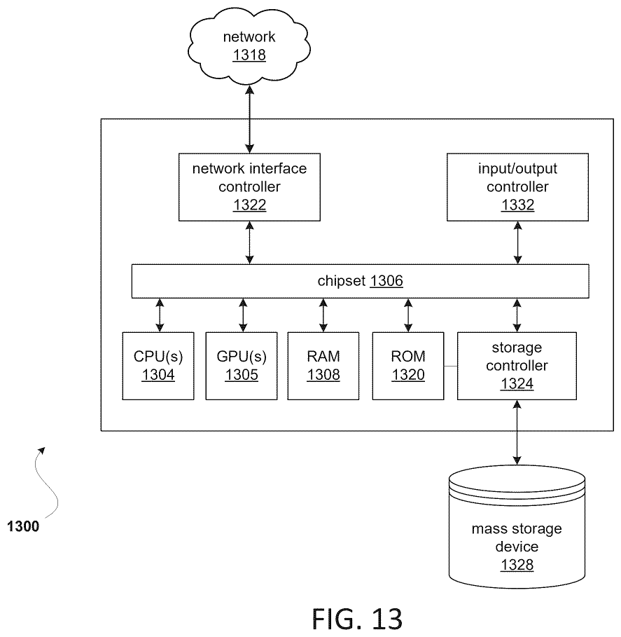

FIG. 13 illustrates a computing device that can be used in various aspects, such as the services, networks, modules, and/or devices depicted in any of FIGS. 1-4. With regard to FIGS. 1-4, any or all of the components can each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and can be utilized to execute any aspects of the computers described herein, such as to implement the methods described herein.

The computing device 1300 can include a baseboard, or “motherboard,” which is a printed circuit board to which a multitude of components or devices can be connected by way of a system bus or other electrical communication paths. One or more central processing units (CPUs) 1304 can operate in conjunction with a chipset 1306. The CPU(s) 1304 can be standard programmable processors that perform arithmetic and logical operations necessary for the operation of the computing device 1300.

The CPU(s) 1304 can perform the necessary operations by transitioning from one discrete physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits including registers, adders-subtractors, arithmetic logic units, floating-point units, and the like.

The CPU(s) 1304 can be augmented with or replaced by other processing units, such as GPU(s) 1305. The GPU(s) 1305 can comprise processing units specialized for but not necessarily limited to highly parallel computations, such as graphics and other visualization-related processing.

A chipset 1306 can provide an interface between the CPU(s) 1304 and the remainder of the components and devices on the baseboard. The chipset 1306 can provide an interface to a random-access memory (RAM) 1308 used as the main memory in the computing device 1300. The chipset 1306 can further provide an interface to a computer-readable storage medium, such as a read-only memory (ROM) 1320 or non-volatile RAM (NVRAM) (not shown), for storing basic routines that can help to start up the computing device 1300 and to transfer information between the various components and devices. ROM 1320 or NVRAM can also store other software components necessary for the operation of the computing device 1300 in accordance with the aspects described herein.

The computing device 1300 can operate in a networked environment using logical connections to remote computing nodes and computer systems through local area network (LAN). The chipset 1306 can include functionality for providing network connectivity through a network interface controller (NIC) 1322, such as a gigabit Ethernet adapter. A NIC 1322 can be capable of connecting the computing device 1300 to other computing nodes over a network 1318. It should be appreciated that multiple NICs 1322 can be present in the computing device 1300, connecting the computing device to other types of networks and remote computer systems.

The computing device 1300 can be connected to a mass storage device 1328 that provides non-volatile storage for the computer. The mass storage device 1328 can store system programs, application programs, other program modules, and data, which have been described in greater detail herein. The mass storage device 1328 can be connected to the computing device 1300 through a storage controller 1324 connected to the chipset 1306. The mass storage device 1328 can consist of one or more physical storage units. The mass storage device 1328 can comprise a management component 1313. A storage controller 1324 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 can store data on the mass storage device 1328 by transforming the physical state of the physical storage units to reflect the information being stored. The specific transformation of a physical state can depend on various factors and on different implementations of this description. Examples of such factors can include, but are not limited to, the technology used to implement the physical storage units and whether the mass storage device 1328 is characterized as primary or secondary storage and the like.

For example, the computing device 1300 can store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 can further read information from the mass storage device 1328 by detecting the physical states or characteristics of one or more particular locations within the physical storage units.

In addition to the mass storage device 1328 described above, the computing device 1300 can have access to other computer-readable storage media to store and retrieve information, such as program modules, data structures, or other data. It should be appreciated by those skilled in the art that computer-readable storage media can be any available media that provides for the storage of non-transitory data and that can be accessed by the computing device 1300.

By way of example and not limitation, computer-readable storage media can include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that can be used to store the desired information in a non-transitory fashion.

A mass storage device, such as the mass storage device 1328 depicted in FIG. 13, can store an operating system utilized to control the operation of the computing device 1300. The operating system can comprise a version of the LINUX operating system. The operating system can comprise a version of the WINDOWS SERVER operating system from the MICROSOFT Corporation. According to further aspects, the operating system can comprise a version of the UNIX operating system. Various mobile phone operating systems, such as IOS and ANDROID, can also be utilized. It should be appreciated that other operating systems can also be utilized. The mass storage device 1328 can store other system or application programs and data utilized by the computing device 1300.

The mass storage device 1328 or other computer-readable storage media can also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 can have access to computer-readable storage media storing computer-executable instructions, which, when executed by the computing device 1300, can perform the methods described herein.

A computing device, such as the computing device 1300 depicted in FIG. 13, can also include an input/output controller 1332 for receiving and processing input from a number of input devices, such as a keyboard, a mouse, a touchpad, a touch screen, an electronic stylus, or other type of input device. Similarly, an input/output controller 1332 can provide output to a display, such as a computer monitor, a flat-panel display, a digital projector, a printer, a plotter, or other type of output device. It will be appreciated that the computing device 1300 can not include all of the components shown in FIG. 13, can include other components that are not explicitly shown in FIG. 13, or can utilize an architecture completely different than that shown in FIG. 13.

As described herein, a computing device can be a physical computing device, such as the computing device 1300 of FIG. 13. A computing node can also include a virtual machine host process and one or more virtual machine instances. Computer-executable instructions can be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance can or can not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that can be used to perform the described methods and systems. When combinations, subsets, interactions, groups, etc., of these components are described, it is understood that while specific references to each of the various individual and collective combinations and permutations of these can not be explicitly described, each is specifically contemplated and described herein, for all methods and systems. This applies to all aspects of this application including, but not limited to, operations in described methods. Thus, if there are a variety of additional operations that can be performed it is understood that each of these additional operations can be performed with any specific embodiment or combination of embodiments of the described methods.

The present methods and systems can be understood more readily by reference to the following detailed description of preferred embodiments and the examples included therein and to the Figures and their descriptions.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions can be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions can also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above can be used independently of one another or can be combined in various ways. All possible combinations and sub-combinations are intended to fall within the scope of this disclosure. In addition, certain methods or process blocks can be omitted in some implementations. The methods and processes described herein are also not limited to any particular sequence, and the blocks or states relating thereto can be performed in other sequences that are appropriate. For example, described blocks or states can be performed in an order other than that specifically described, or multiple blocks or states can be combined in a single block or state. The example blocks or states can be performed in serial, in parallel, or in some other manner. Blocks or states can be added to or removed from the described example embodiments. The example systems and components described herein can be configured differently than described. For example, elements can be added to, removed from, or rearranged compared to the described example embodiments.

It will also be appreciated that various items are illustrated as being stored in memory or on storage while being used, and that these items or portions thereof can be transferred between memory and other storage devices for purposes of memory management and data integrity. Alternatively, in other embodiments, some or all of the software modules and/or systems can execute in memory on another device and communicate with the illustrated computing systems via inter-computer communication. Furthermore, in some embodiments, some or all of the systems and/or modules can be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures can also be stored (e.g., as software instructions or structured data) on a computer-readable medium, such as a hard disk, a memory, a network, or a portable media article to be read by an appropriate device or via an appropriate connection. The systems, modules, and data structures can also be transmitted as generated data signals (e.g., as part of a carrier wave or other analog or digital propagated signal) on a variety of computer-readable transmission media, including wireless-based and wired/cable-based media, and can take a variety of forms (e.g., as part of a single or multiplexed analog signal, or as multiple discrete digital packets or frames). Such computer program products can also take other forms in other embodiments. Accordingly, the present invention can be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations can be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of generating images using a machine learning model, comprising:
receiving a source image and a driving image by the machine learning model, wherein the source image comprises a portrait of a first subject, the driving image comprises a second subject that is different from the first subject, the driving image depicts a pose or a visage, and the machine learning model comprises a first sub-model and a second sub-model;
extracting appearance features of the first subject from the source image by the first sub-model;
generating a masked image based on the driving image, wherein the masked image comprises at least one of a mouth region or eye regions in the driving image;
deriving the pose or the visage based on the driving image and the masked images by the second sub-model; and
generating an image by the machine learning model, wherein the generated image preserves the appearance features of the first subject and follows the pose or the visage depicted in the driving image.

2. The method of claim 1, wherein the second sub-model is trained by applying a cross-identity training scheme, and the cross-identity training scheme is configured to instruct the second sub-model to derive identity-disentangled poses or visages.

3. The method of claim 2, wherein the applying a cross-identity training scheme comprises:
generating cross-identity image pairs each of which comprises different subjects; and
training the second sub-model on the cross-identity image pairs to mitigate appearance leakage from driving signals.

4. The method of claim 3, wherein generating each cross-identity image pair comprises:
selecting an appearance reference image and a reconstruction target image that feature a same subject; and
generating a control image by a pre-trained image reenactment generator, wherein the control image features a subject different from the subject in the appearance reference image and the reconstruction target image, and wherein the control image shares motion information with the reconstruction target image.

5. The method of claim 4, further comprising:
generating local control images based on control images in the cross-identity image pairs, wherein each of the local control images comprises at least one of a mouth region or eye regions; and
guiding the second sub-model to enhance attention to local facial movements using the local control images.

6. The method of claim 4, further comprising:
performing random heterogeneous scaling operations on control images and local control images during training to force the machine learning model to derive appearance features from appearance reference images.

7. The method of claim 6, where a random scaling factor of the random heterogeneous scaling operations is greater than or equal to 0.9 and less than or equal to 1.1.

8. The method of claim 1, wherein the pose comprises a head pose, and the visage comprises a facial visage.

9. The method of claim 1, further comprising:
receiving the source image and a driving video by the machine learning model, wherein the driving video comprises a sequence of frames and features the second subject with motions associated with a head or a face; and
generating a video by the machine learning model, wherein the generated video preserves the appearance features of the first subject and follows the motions depicted in the driving video.

10. A system of generating images using a machine learning model, comprising:
at least one processor; and
at least one memory communicatively coupled to the at least one processor and comprising computer-readable instructions that upon execution by the at least one processor cause the at least one processor to perform operations comprising:
receiving a source image and a driving image by the machine learning model, wherein the source image comprises a portrait of a first subject, the driving image comprises a second subject that is different from the first subject, the driving image depicts a pose or a visage, and the machine learning model comprises a first sub-model and a second sub-model;
extracting appearance features of the first subject from the source image by the first sub-model;
generating a masked image based on the driving image, wherein the masked image comprises at least one of a mouth region or eye regions in the driving image;
deriving the pose or the visage based on the driving image and the masked images by the second sub-model; and
generating an image by the machine learning model, wherein the generated image preserves the appearance features of the first subject and follows the pose or the visage depicted in the driving image.

11. The system of claim 10, wherein the second sub-model is trained by applying a cross-identity training scheme, wherein the cross-identity training scheme is configured to instruct the second sub-model to derive identity-disentangled poses or visages, and wherein the applying a cross-identity training scheme comprises:
generating cross-identity image pairs each of which comprises different subjects; and
training the second sub-model on the cross-identity image pairs to mitigate appearance leakage from driving signals.

12. The system of claim 11, wherein generating each cross-identity image pair comprises:
selecting an appearance reference image and a reconstruction target image that feature a same subject; and
generating a control image by a pre-trained image reenactment generator, wherein the control image features a subject different from the subject in the appearance reference image and the reconstruction target image, and wherein the control image shares motion information with the reconstruction target image.

13. The system of claim 12, the operations further comprising:
generating local control images based on control images in the cross-identity image pairs, wherein each of the local control images comprises at least one of a mouth region or eye regions; and
guiding the second sub-model to enhance attention to local facial movements using the local control images.

14. The system of claim 12, the operations further comprising:
performing random heterogeneous scaling operations on control images and local control images during training to force the machine learning model to derive appearance features from appearance reference images.

15. The system of claim 10, the operations further comprising:
receiving the source image and a driving video by the machine learning model, wherein the driving video comprises a sequence of frames and features the second subject with motions associated with a head or a face; and
generating a video by the machine learning model, wherein the generated video preserves the appearance features of the first subject and follows the motions depicted in the driving video.

16. A non-transitory computer-readable storage medium, storing computer-readable instructions that upon execution by a processor cause the processor to implement operations comprising:
receiving a source image and a driving image by a machine learning model, wherein the source image comprises a portrait of a first subject, the driving image comprises a second subject that is different from the first subject, the driving image depicts a pose or a visage, and the machine learning model comprises a first sub-model and a second sub-model;
extracting appearance features of the first subject from the source image by the first sub-model;
generating a masked image based on the driving image, wherein the masked image comprises at least one of a mouth region or eye regions in the driving image;
deriving the pose or the visage based on the driving image and the masked images by the second sub-model; and
generating an image by the machine learning model, wherein the generated image preserves the appearance features of the first subject and follows the pose or the visage depicted in the driving image.

17. The non-transitory computer-readable storage medium of claim 16, wherein the second sub-model is trained by applying a cross-identity training scheme, wherein the cross-identity training scheme is configured to instruct the second sub-model to derive identity-disentangled poses or visages, and wherein the applying a cross-identity training scheme comprises:
generating cross-identity image pairs each of which comprises different subjects; and
training the second sub-model on the cross-identity image pairs to mitigate appearance leakage from driving signals.

18. The non-transitory computer-readable storage medium of claim 17, wherein generating each cross-identity image pair comprises:
selecting an appearance reference image and a reconstruction target image that feature a same subject; and
generating a control image by a pre-trained image reenactment generator, wherein the control image features a subject different from the subject in the appearance reference image and the reconstruction target image, and wherein the control image shares motion information with the reconstruction target image.

19. The non-transitory computer-readable storage medium of claim 18, the operations further comprising:
generating local control images based on control images in the cross-identity image pairs, wherein each of the local control images comprises at least one of a mouth region or eye regions; and
guiding the second sub-model to enhance attention to local facial movements using the local control images.

20. The non-transitory computer-readable storage medium of claim 18, the operations further comprising:
performing random heterogeneous scaling operations on control images and local control images during training to force the machine learning model to derive appearance features from appearance reference images.
